(19) United States
(12) Patent Application Publication
(10) Pub. No.: US 2005/0057635 A1
(43) Pub. Date: Mar. 17, 2005

(54) Image forming apparatus

(75) Inventor: Isao Kubo, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/939,885

(22) Filed: Sep. 14, 2004

(30) Foreign Application Priority Data
Sep. 16, 2003 (JP) 2003-323620

(51) Int. Cl. B41J 2/385

(52) U.S. Cl. 347/130

(57) ABSTRACT

An image forming apparatus has a light-emitting device, a photosensitive member being exposed to the light to form an electrostatic latent image on the photosensitive member, an image forming portion that forms an image corresponding to the electrostatic latent image on a recording medium, a cover, a light-emitting device control circuit, a first power supply that supplies electric power to the light-emitting device, a second power supply that supplies electric power to the light-emitting device control circuit, and a controller that includes a detection unit that detects the opening and closing of the cover and a power supply controller to control the electric power so that the first power supply stops to supply the electric power to the light-emitting device while the second power supply supplies the electric power to the light-emitting device control circuit when the detection unit detects the cover is open.

### BACKGROUND OF THE INVENTION

1. Field of the Invention

The present invention relates to image formation in which an image corresponding to an electrostatic latent image formed on a photosensitive member exposed to light emitted from a light-emitting device is formed on a recording medium by electrophotography.

2. Description of the Related Art

Conventionally, there has been proposed an image forming apparatus having: a light-emitting device for exposing a photosensitive member to light to thereby form an electrostatic latent image on the photosensitive member; an image forming portion for forming an image corresponding to the electrostatic latent image on a recording medium by electrophotography; and a light-emitting device control circuit for controlling the drive of the light-emitting device. In this type image forming apparatus, the photosensitive member is exposed to light suitably while the drive of the light-emitting device is controlled by the light-emitting device control circuit. In this manner, a desired electrostatic latent image corresponding to image data or the like is formed on the photosensitive member. In the image forming portion, an image corresponding to the electrostatic latent image can be formed on a recording medium by electrophotography.

Generally, this type image forming apparatus further has a cover which can be opened and closed so that light emitted from the light-emitting device can be prevented from entering an optical path from the outside of a housing of the apparatus. It is preferable that a user is not irradiated with light emitted from the light-emitting device when the cover is opened.

It is therefore conceived that when the cover is opened, a mechanical shutter is closed so that light can be cut off in the neighborhood of the light-emitting device even in the case where the light is emitted from the light-emitting device. As a surer method, there has been proposed a method in which a detection unit such as an interlock switch is provided for detecting the opening/closing of the cover so that power supply to the light-emitting device and the light-emitting device control circuit is stopped when the cover is opened (e.g. see JP-A-7-244452).

### SUMMARY OF THE INVENTION

When an interlock switch or the like is used for stopping power supply to the light-emitting device and the light-emitting device control circuit, an over-voltage is however applied on the light-emitting device control circuit at the moment that the cover is closed to restart the power supply. When the light-emitting device control circuit is formed from an IC or the like, there is a possibility that the IC will be broken by the over-voltage. In addition, when a signal is input to an input terminal of the IC in the condition that the IC is not supplied with electric power, there is a possibility that the IC will be broken.

FIG. 4 is a time chart showing change in applied voltage in the case where a mechanical switch such as an interlock switch is closed to connect a certain circuit to a 5V source. In FIG. 4, each of vertical divisions of a tessellated scale expresses 2 V. In this example, the applied voltage once fluctuates from 0 V and then converges to 5 V. In this case, the over-voltage reaches 8.36 V at maximum, that is, the over-voltage is well over the rated voltage 7 V of the IC.

An image forming apparatus is disclosed herein, in which electric power supply to a light-emitting device can be stopped surely when a cover is opened and in which an IC can be prevented from being broken when the IC is used as a light-emitting device control circuit.

According to one aspect of the invention, there is provided an image forming apparatus including: a light-emitting device that emits light, a photosensitive member being exposed to the light to form an electrostatic latent image on the photosensitive member; an image forming portion that forms an image corresponding to the electrostatic latent image on a recording medium by electrophotography; a cover that is opened and closed; a light-emitting device control circuit that controls the light-emitting device; a first power supply that supplies electric power to the light-emitting device; a second power supply that supplies electric power to the light-emitting device control circuit; and a controller that includes a detection unit that detects the opening and closing of the cover and a power supply controller to control the electric power so that the first power supply stops to supply the electric power to the light-emitting device while the second power supply supplies the electric power to the light-emitting device control circuit when the detection unit detects the cover is open.

The image forming apparatus according to the invention has the first power supply for supplying electric power to drive the light-emitting device, and the second power supply for supplying electric power to drive the light-emitting device control circuit. When the detection unit detects the opening of the cover, power supply based on the first power supply is stopped while power supply based on the second power supply is continued. For this reason, electric power supply to the light-emitting device control circuit on the basis of the second power supply is continued regardless of whether the cover is opened or closed, so that an over-voltage can be prevented from being applied on a power supply line led from the second power supply even in the case where the cover is closed. In addition, when the detection unit detects the opening of the cover, electric power supply to the light-emitting device on the basis of the first power supply is stopped.

When the cover is opened, electric power supply based on the first power supply is stopped so that electric power supply to the light-emitting device can be stopped surely. On the other hand, electric power supply to the light-emitting device control circuit on the basis of the second power supply is continued regardless of whether the cover is opened or closed. For this reason, an over-voltage is not applied on a power supply line led from the second power supply even in the case where the cover is closed. Accordingly, in the invention, an IC can be effectively prevented from being broken even in the case where the IC is used as the light-emitting device control circuit. In addition, because electric power supply to the light-emitting device control circuit is continued, the IC can be effectively prevented from being broken even in the case where a signal is input to the light-emitting device control circuit at the time of the opening of the cover.

### BRIEF DESCRIPTION OF THE DRAWINGS

The present invention may be more readily described with reference to the accompanying drawings:

FIG. 1 is a sectional view showing the schematic configuration of a laser printer to which the invention is applied;

FIG. 2 is a plan view showing the schematic configuration of a scanner unit in the laser printer;

FIG. 3 is an explanatory diagram showing the schematic configuration of a laser diode drive control system; and

FIG. 4 is a time chart showing change in voltage in the case where an over-voltage is generated.

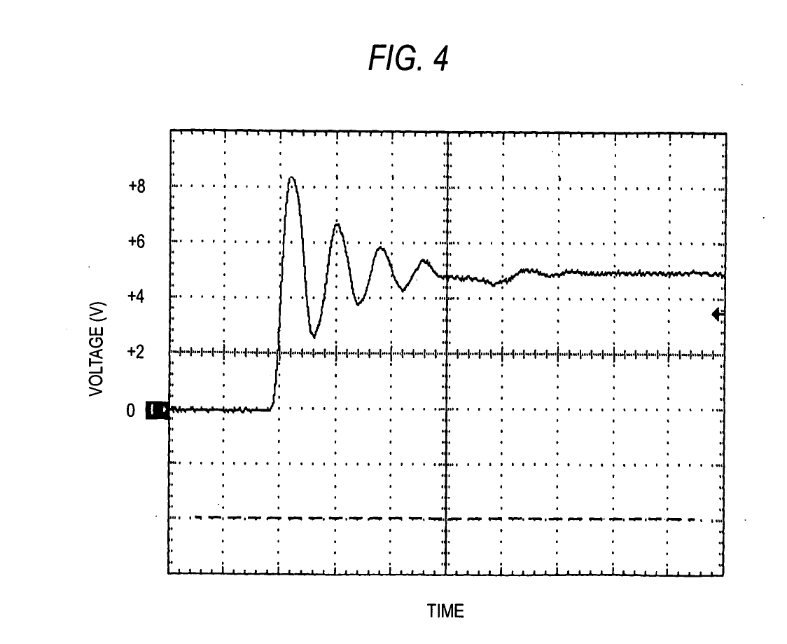

### DETAILED DESCRIPTION OF THE PREFERRED EMBODIMENTS

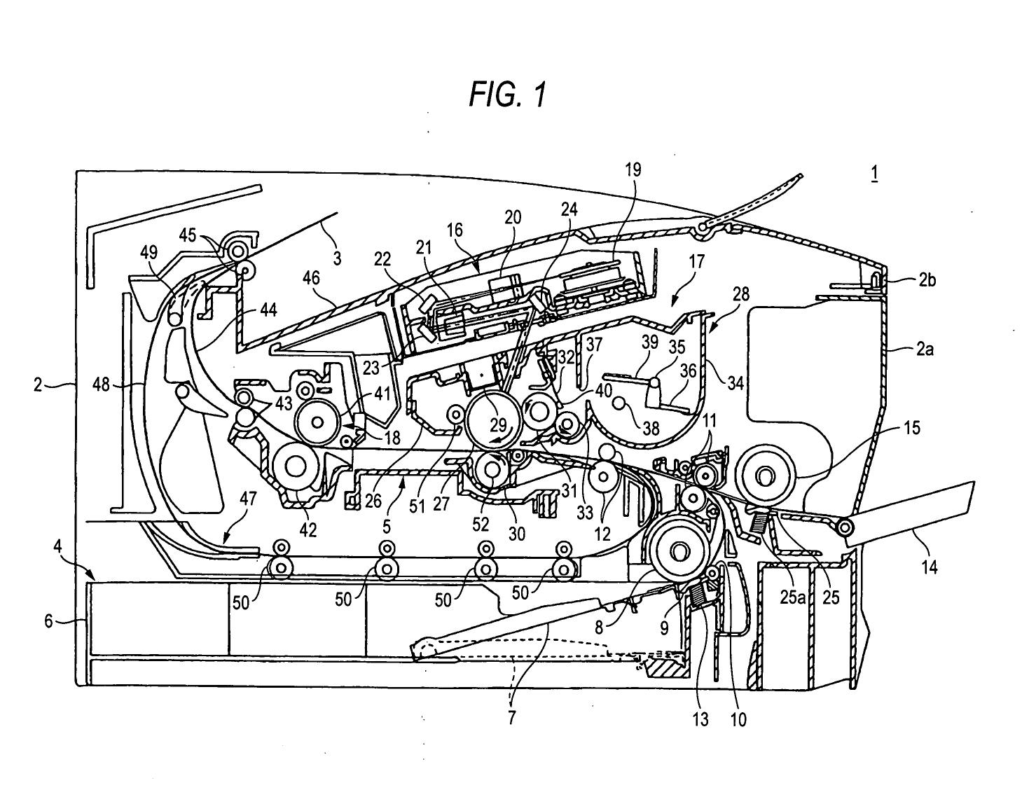

An embodiment of the invention will be described below with reference to the drawings. FIG. 1 is a sectional view showing an embodiment of a laser printer as an image forming apparatus according to the invention. As shown in FIG. 1, the laser printer 1 in this embodiment has a housing 2. A feeder portion 4 for feeding a sheet of paper 3 as a recording medium, a recording portion 5 for forming a predetermined image on the sheet of paper 3 fed in the aforementioned manner, and so on, are provided in the housing 2.

The feeder portion 4 has: a paper feed tray 6 detachably attached to a bottom portion in the housing 2; a paper pressing plate 7 provided in the paper feed tray 6; a paper feed roller 8 and a paper feed pad 9 provided above an end portion of the paper feed tray 6; paper dust removing rollers 10 and 11 provided on a downstream side of the paper feed roller 8 in a direction of conveying the sheet of paper 3; and registration rollers 12 provided on a downstream side of the paper dust removing rollers 10 and 11 in the direction of conveying the sheet of paper 3.

The paper pressing plate 7 is provided so that sheets of paper 3 can be stacked stratiformly. An end portion of the paper pressing plate 7 far from the paper feed roller 8 is pivotally supported so that an opposite end portion of the paper pressing plate 7 near to the paper feed roller 8 can move up and down. A not-shown spring provided on the back of the paper pressing plate 7 urges the paper pressing plate 7 to move up. For this reason, the end portion far from the paper feed roller 8 serves as a fulcrum so that the paper pressing plate 7 is moved down against the urging force of the spring in accordance with increase in the number of sheets of paper 3 stacked. The paper feed roller 8 and the paper feed pad 9 are disposed opposite to each other. The paper feed pad 9 is pressed against the paper feed roller 8 by a spring 13 disposed on the back of the paper feed pad 9. The uppermost one of the sheets of paper 3 on the paper pressing plate 7 is pressed against the paper feed roller 8 by the spring provided on the back of the paper pressingplate 7. After clamped between the paper feed roller 8 and the paper feed pad 9 by rotation of the paper feed roller 8, the uppermost sheet of paper is fed. In this manner, the sheets of paper 3 are fed one by one.

The sheet of paper 3 fed in the aforementioned manner is sent to the registration rollers 12 after paper dust is removed by the paper dust removing rollers 10 and 11. The registration rollers 12 are formed as a pair of rollers and provided so that the sheet of paper 3 is sent to the recording portion 5 after predetermined registration is made.

Incidentally, the feeder portion 4 further has: a multi-purpose tray 14; and a multi-purpose side paper feed roller 15 and a multi-purpose side paper feed pad 25 for feeding sheets of paper 3 stacked on the multi-purpose tray 14. The multi-purpose side paper feed roller 15 and the multi-purpose side paper feed pad 25 are disposed opposite to each other. The multi-purpose side paper feed pad 25 is pressed against the multi-purpose side paper feed roller 15 by a spring 25a disposed on the back of the multi-purpose side paper feed pad 25. The sheets of paper 3 stacked on the multi-purpose tray 14 are fed one by one after clamped between the multi-purpose side paper feed roller 15 and the multi-purpose side paper feed pad 25 by rotation of the multi-purpose side paper feed roller 15.

The recording portion 5 has a scanner unit 16, a process unit 17 serving as an image forming portion, a fixing portion 18, etc.

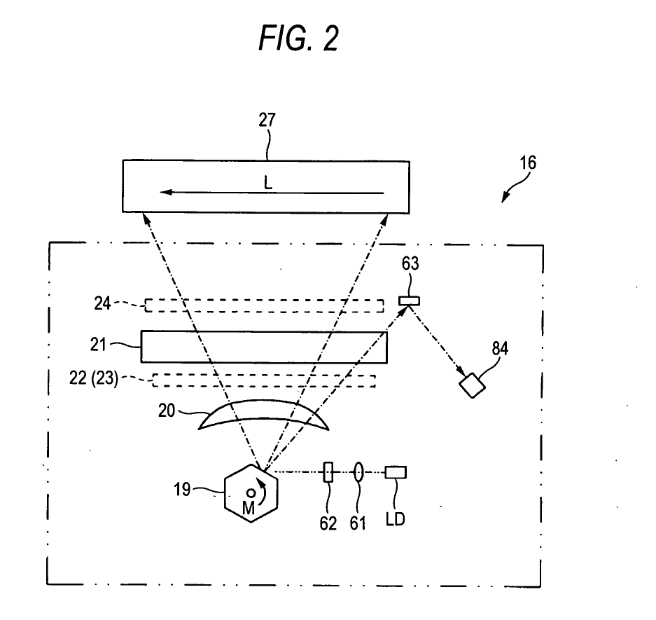

The scanner unit 16 is provided in an upper portion in the housing 2. The scanner unit 16 has a laser diode LD (not shown in FIG. 1 but shown in FIG. 2) as a light-emitting device, a polygon mirror 19 driven to rotate, lenses 20 and 21, reflection mirrors 22, 23 and 24, etc. As represented by chain lines, a laser beam emitted from the laser diode LD on the basis of predetermined image data is transmitted through or reflected on the polygon mirror 19, the fO lens 20, the reflection mirrors 22 and 23, the cylinder lens 21 and the reflection mirror 24 successively, so that the resulting beam is applied on a surface of a photosensitive drum 27 of the process unit 17 (which will be described later) by high speed scanning.

The process unit 17 is disposed below the scanner unit 16. The process unit 17 has a drum cartridge 26 detachably attached to the housing 2. A photosensitive drum 27 as a photosensitive member, a developing cartridge 28, a scorotron charger 29, a transfer roller 30, a cleaning brush 51, and so on, are provided in the drum cartridge 26.

The developing cartridge 28 is detachably attached to the drum cartridge 26. The developing cartridge 28 has a developing roller 31, a layer thickness limiting blade 32, a feed roller 33, and a toner box 34.

The toner box 34 is filled with toner having a nonmagnetic component capable of being charged with positive electricity as a developer. Polymeric toner is used as the toner. The polymeric toner can be prepared in such a manner that polymerizable monomers are copolymerized by a known polymerization method such as suspension polymerization. Examples of the polymerizable monomers include: styrene monomers such as styrene; and acrylic monomers such as acrylic acid, alkyl (C1 to C4) acrylate and alkyl (C1 to C4) methacrylate. The polymeric toner is globular, so that the polymeric toner exhibits very good fluidity. Incidentally, a coloring agent such as carbon black or the like, wax, and soon, may be mixed with the toner. An external additive such as silica may be added to the toner in order to improve fluidity. The particle size of the toner is in a range of from about 6 μm to about 10 μm.

The toner in the toner box 34 is released from a toner inlet 37 after agitated by an agitator 36 supported to a rotation shaft 35 provided in the center of the toner box 34. Incidentally, a window 38 for detecting the residual amount of toner is provided in a side wall of the toner box 34 so that the toner box 34 can be cleaned by a cleaner 39 supported to the rotation shaft 35.

The feed roller 33 is disposed on a side of the toner inlet 37 so as to be rotatable. The developing roller 31 is disposed opposite to the feed roller 33 so as to be rotatable. The feed roller 33 and the developing roller 31 abut on each other while compressed to a certain degree.

The feed roller 33 has a metal roller shaft covered with a roller made of an electrically conductive foam material. The developing roller 31 has a metal roller shaft covered with a roller made of an electrically conductive rubber material. More specifically, the roller portion of the developing roller 31 is formed in such a manner that a roller body made of electrically conductive urethane or silicone rubber containing carbon fine particles is coated with a coat layer of urethane or silicone rubber containing fluorine. Incidentally, a predetermined developing bias voltage relative to the photosensitive drum 27 is applied on the developing roller 31.

The layer thickness limiting blade 32 is disposed near the developing roller 31. The layer thickness limiting blade 32 has a presser portion 40 provided at a front end portion of a blade body made of a metal leaf spring material. The presser portion 40 is made of electrically insulating silicone rubber and shaped like a semi-circle in sectional view. The layer thickness limiting blade 32 is supported to the developing cartridge 28 in the neighborhood of the developing roller 31 so that the presser portion 40 is brought into pressure contact with the developing roller 31 by the elastic force of the blade body.

The toner released from the toner inlet 37 is supplied onto the developing roller 31 by rotation of the feed roller 33. On this occasion, the toner is charged with positive frictional electricity between the feed roller 33 and the developing roller 31. The toner supplied onto the developing roller 31 penetrates between the presser portion 40 of the layer thickness limiting blade 32 and the developing roller 31 with the rotation of the developing roller 31, so that the toner is further sufficiently charged with frictional electricity. As a result, the toner is carried as a thin layer having a predetermined thickness on the developing roller 31.

The photosensitive drum 27 is disposed on a side of the developing roller 31 so that the photosensitive drum 27 can rotate while opposed to the developing roller 31. The photosensitive drum 27 has a drum body grounded, and a surface portion provided as a photosensitive layer capable of being charged with positive electricity and made of polycarbonate or the like.

The scorotron charger 29 is disposed at a predetermined distance above the photosensitive drum 27 so as to be prevented from coming into contact with the photosensitive drum 27. The scorotron charger 29 is a scorotron charger which is used for positive charge so that corona discharge is generated from a charging wire such as a tungsten wire. The scorotron charger 29 is formed so that a surface of the photosensitive drum 27 is evenly charged with electricity of positive polarity.

After evenly charged with positive electricity by the scorotron charger 29, the surface of the photosensitive drum 27 is exposed to a laser beam emitted from the scanner unit 16 by high-speed scanning. Thus, an electrostatic latent image based on predetermined image data is formed on the surface of the photosensitive drum 27. Then, with rotation of the developing roller 31, toner carried on the developing roller 31 and charged with positive electricity is supplied to the electrostatic latent image formed on the surface of the photosensitive drum 27, that is, to a light-exposed portion which is part of the surface of the photosensitive drum 27 evenly charged with positive electricity and which has an electric potential reduced by the laser beam exposure, when the developing roller 31 facing the photosensitive drum 27 comes into contact with the photosensitive drum 27. As a result, the toner is selectively carried on the light-exposed portion to thereby make the electrostatic latent image visible. In this manner, reversal developing is achieved.

The transfer roller 30 is disposed below the photosensitive drum 27 so as to be opposite to the photosensitive drum 27. The transfer roller 30 is supported to the drum cartridge 26 so as to be rotatable. As the transfer roller 30, there is used an ion conduction type transfer roller having a metal roller shaft 52 covered with a roller made of an elastic material containing an ionic substance such as lithium perchlorate. The resistance of the transfer roller 30 is selected to be in a range of from 107 Ω to 108.5 Ω at 22° C. and 50% RH. According to the transfer roller 30, the sheet of paper 3 can be conveyed well while the electrostatic latent image formed on the photosensitive drum 27 is transferred onto the sheet of paper 3.

The transfer roller 30 is formed so that a predetermined transfer bias voltage is applied on the photosensitive drum 27 by a not-shown transfer bias application circuit when the toner is transferred. For this reason, the visible image carried on the surface of the photosensitive drum 27 is transferred onto the sheet of paper 3 while the sheet of paper 3 facing the transfer roller 30 passes between the photosensitive drum 27 and the transfer roller 30. That is, the process unit 17 operates so that an image corresponding to the electrostatic latent image formed on the photosensitive drum 27 provided as a photosensitive member can be formed on the sheet of paper 3 by electrophotography.

The cleaning brush 51 is prepared in such a manner that electrically conductive fibers are implanted radially from a rotation shaft. The cleaning brush 51 is provided on a downstream side of the transfer roller 30 and on an upstream side of the scorotron charger 29 in the direction of rotation of the photosensitive drum 27 so that the cleaning brush 51 comes into contact with the surface of the photosensitive drum 27. Paper dust deposited on the surface of the photosensitive drum 27 is removed by the cleaning brush 51 after the toner is transferred.

As shown in FIG. 1, the fixing portion 18 is disposed on a downstream side of a side of the process unit 17. The fixing portion 18 has a heat roller 41, a pressure roller 42 for pressing the heat roller 41, and a pair of conveyance rollers 43 provided on a downstream side of the heat and pressure rollers 41 and 42. The heat roller 41 is made of metal and provided with a halogen lamp for generating heat. The fixing portion 18 is provided so that the toner transferred onto the sheet of paper 3 by the process unit 17 is thermally fixed while the sheet of paper 3 passes between the heat roller 41 and the pressure roller 42, and that the sheet of paper 3 is then conveyed to a paper ejection path 44 by the conveyance rollers 43. The sheet of paper 3 sent to the paper ejection path 44 is further sent to a pair of paper ejection rollers 45 and ejected onto a paper ejection tray 46 by the pair of paper ejection rollers 45.

The housing 2 in which the scanner unit 16, the process unit 17, the fixing portion 18, etc. are put has a housing body 2a, and a cover 2b which can be opened and closed relative to the housing body 2a. When the cover 2b is closed, the optical path of the laser beam emitted from the laser diode LD of the scanner unit 16 can be prevented from being invaded by light from the outside of the housing 2.

The laser printer 1 further has a reverse conveyance portion 47 provided for forming images on both surfaces of the sheet of paper 3. The reverse conveyance portion 47 has a pair of paper ejection rollers 45, a reverse conveyance path 48, a flapper 49, and pairs of reverse conveyance rollers 50.

The paper ejection rollers 45 are provided as a pair of rollers which are formed so that rotation can be switched between normal rotation and reverse rotation. As described above, the paper ejection rollers 45 rotate normally when the sheet of paper 3 is ejected onto the paper ejection tray 46, but rotate reversely when the sheet of paper 3 is inverted.

The reverse conveyance path 48 is provided along the vertical direction so that the sheet of paper 3 can be conveyed from the paper ejection rollers 45 to the reverse conveyance rollers 50 disposed below the recording portion 5. The reverse conveyance path 48 has an upstream end portion disposed near the paper ejection rollers 45, and a downstream end portion disposed near the reverse conveyance rollers 50.

The flapper 49 is rotatably provided so as to face on a junction between the paper ejection path 44 and the reverse conveyance path 48. The flapper 49 is formed so that the direction of conveying the sheet of paper 3 inverted by the paper ejection rollers 45 can be switched from a direction toward the paper ejection path 44 to a direction toward the reverse conveyance path 48 in accordance with whether a not-shown solenoid is excited or not.

The pairs of reverse conveyance rollers 50 are provided substantially horizontally above the paper feed tray 6 so that a pair of reverse conveyance rollers 50 on the most upstream side are disposed near the rear end portion of the reverse conveyance path 48 while a pair of reverse conveyance rollers 50 on the most downstream side are disposed below the pair of registration rollers 12.

When images need to be formed on opposite surfaces of the sheet of paper 3, the reverse conveyance portion 47 operates as follows. That is, when the sheet of paper 3 having an image formed on its one surface is delivered to the paper ejection rollers 45 through the paper ejection path 44 by the conveyance rollers 43, the paper ejection rollers 45 rotate normally while the sheet of paper 3 is clamped between the paper ejection rollers 45. In this manner, the sheet of paper 3 is once conveyed outward (toward the paper ejection tray 46). When large part of the sheet of paper 3 is sent outward so that the rear end of the sheet of paper 3 is clamped between the paper ejection rollers 45, normal rotation of the paper ejection rollers 45 is stopped. Then, the paper ejection rollers 45 rotate reversely while the flapper 49 switches the conveyance direction so that the sheet of paper 3 is conveyed to the reverse conveyance path 48. In this manner, the sheet of paper 3 is conveyed to the reverse conveyance path 48 in the condition that the direction of movement of the sheet of paper 3 is reversed. Incidentally, when conveyance of the sheet of paper 3 is completed, the state of the flapper 49 is switched to the original state, that is, a state in which the sheet of paper 3 delivered from the conveyance rollers 43 is sent to the paper ejection rollers 45. Then, the sheet of paper 3 reversely conveyed to the reverse conveyance path 48 is further conveyed to the reverse conveyance rollers 50. The sheet of paper 3 is sent upward from the reverse conveyance rollers 50 to the registration rollers 12 while turned upside down. After predetermined registration, the sheet of paper 3 delivered to the registration rollers 12 is sent to the recording portion 5 again while the upside-down state of the sheet of paper 3 is kept as it is. As a result, predetermined images are formed on opposite surfaces of the sheet of paper 3.

The laser printer 1 is designed so that the residual toner is collected by a so-called “cleanerless” method in which the toner remaining on the surface of the photosensitive drum 27 after transferring onto the sheet of paper 3 by the transfer roller 30 is collected by the developing roller 31. When the toner remaining on the photosensitive drum 27 is collected by the cleanerless method, simplification in apparatus configuration and reduction in size and cost can be attained because it is unnecessary to provide any cleaner device such as a blade and any waste toner reserving unit.

The scanner unit 16 for scanning the surface of the photosensitive drum 27 with a laser beam will be described below with reference to FIG. 2. FIG. 2 is a plan view showing the schematic configuration of the scanner unit 16. Incidentally, in the plan view of FIG. 2, respective constituent members of the scanner unit 16 are expressed as if they were expanded planarly along the route of the laser beam, for the purpose of describing the outline of the configuration and operation of the scanner unit 16.

As shown in FIG. 2, the scanner unit 16 according to this embodiment has a laser diode LD as a laser beam source. A laser beam emitted from the laser diode LD is converted into a parallel beam by a collimator lens 61. The parallel beam is narrowed only in the sub scanning direction by a cylinder lens 62 so that an image is formed on a side surface of the polygon mirror 19.

The polygon mirror 19 as a scanning unit is rotated in the direction of the arrow M at a high speed by a motor not shown in FIG. 2. The angle of the laser beam is changed by the rotation of the polygon mirror 19, so that the laser beam is scanned (moved) on the surface of the photosensitive drum 27 in a predetermined period in the main scanning direction (the direction of the arrow L). The laser beam reflected on the polygon mirror 19 is subjected to distortion aberration correction by the fθ lens 20. Then, the laser beam is reflected on the reflection mirrors 22 and 23 (see FIG. 1) and narrowed only in the sub scanning direction by the cylinder lens 21. The laser beam output from the cylinder lens 21 is reflected on the reflection mirror 24 and applied on the photosensitive drum 27 provided in the outside of the scanner unit 16.

When the laser beam reflected on the polygon mirror 19 is applied on a reflection mirror 63, the laser beam is reflected on the reflection mirror 63 and applied on a BD sensor 84. The BD sensor 84 has a photo diode in its inside. A signal corresponding to the intensity of the laser beam received by the photo diode is output from the BD sensor 84. The BD sensor 84 is provided for detecting the laser beam before the start of scanning in the main scanning direction to thereby detect a synchronous signal synchronized with the rotational velocity of the polygon mirror 19. Incidentally, the configuration in which the laser beam reflected on the polygon mirror 19 is further reflected on the reflection mirror 63 so as to be received by the BD sensor 84 is only taken as an example. For example, it is a matter of course that the BD sensor 84 may be provided in the position of the reflection mirror 63 so that the laser beam reflected on the polygon mirror 19 can be received directly by the BD sensor 84.

Accordingly, when the laser diode LD is driven suitably on the basis of the signal detected by the BD sensor 84 or on the basis of image data, etc., given from an external personal computer or the like to the laser printer 1, a desired electrostatic latent image can be formed on the photosensitive drum 27 so that a toner image corresponding to the electrostatic latent image can be formed on the sheet of paper 3.

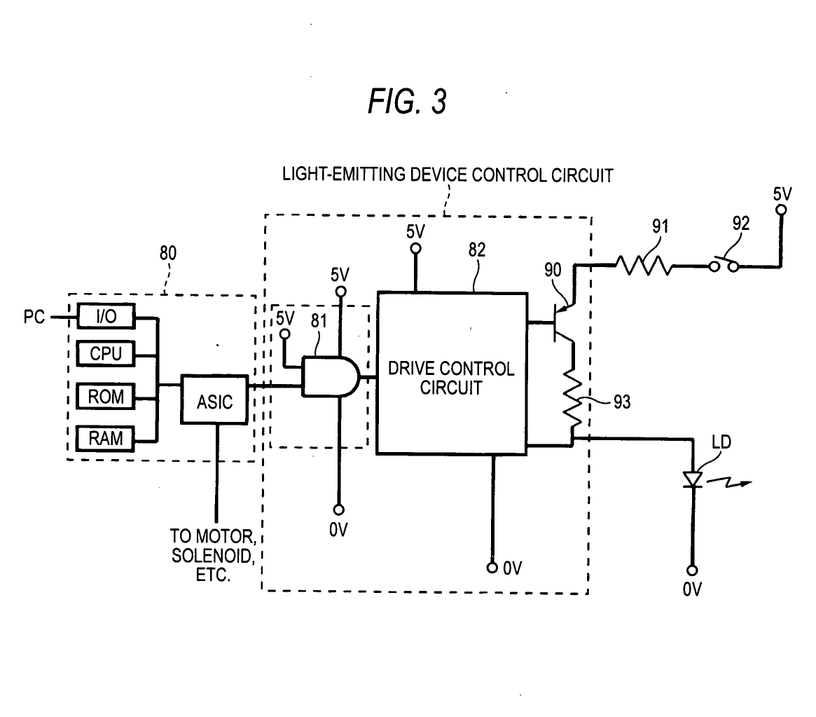

A drive control system of the laser diode LD will be described below. FIG. 3 is an explanatory diagram schematically showing the configuration of the drive control system of the laser diode LD. A laser printer control circuit 80 serving as a center of control such as processing of the image data is disposed in a DC 3.3V signal system. The laser printer control circuit 80 has an interface (I/O), a CPU, an ROM, an RAM, an ASIC, etc. Image data, etc., given from a personal computer (PC) or the like are input to the interface. A control signal output from the ASIC is supplied to a motor, a solenoid, etc. A 3.3V control signal from the ASIC is supplied to one input terminal of an AND circuit 81 in synchronism with the signal detected by the BD sensor.

The other input terminal of the AND circuit 81 is connected to a 5V DC source. The AND circuit 81 outputs a DC 5V signal so that the DC 5V signal is switched on/off in accordance with the on/off of the control signal given from the laser printer control circuit 80. That is, the AND circuit 81 functions as a conversion circuit or IC.

The signal output from the AND circuit 81 is input to a drive control circuit 82. The drive control circuit 82 is a known drive control circuit for controlling the value of the current conducting the laser diode LD to keep the laser beam output constant or for modulating the value of the current conducting the laser diode LD at a high speed in accordance with the signal given from the AND circuit 81. Incidentally, the AND circuit 81 and the drive control circuit 82 are connected to the DC 5V source for drive control and to the ground electrode of 0 V.

The drive control circuit 82 is connected to a transistor 90 through which the current conducting the laser diode LD is controlled as follows. The transistor 90 has a base directly connected to the drive control circuit 82, and an emitter connected to the 5V DC source through a resistor 91 and an interlock switch 92. The interlock switch 92 is a known interlock switch which is turned off when the cover 2b is opened and which is turned on when the cover 2b is closed. That is, the interlock switch 92 functions as a detection unit.

The transistor 90 further has a collector connected to one end of a resistor 93. The other end of the resistor 93 is connected to the drive control circuit 82 directly and to the anode of the laser diode LD. The cathode of the laser diode LD is connected to the ground electrode of 0 V.

Accordingly, the drive control circuit 82 can control the base current of the transistor 90 to control the output of the laser diode LD or to control the laser diode LD to be driven in accordance with the signal given from the AND circuit 81. That is, a combination of the AND circuit 81 as a conversion circuit and the drive control circuit 82 functions as a light-emitting device control circuit.

In the laser printer 1 configured as described above, when the cover 2b is opened so that the interlock switch 92 is turned off, electric power supply to the laser diode LD is stopped regardless of the signal given from the drive control circuit 82 because electric power is not supplied to the emitter of the transistor 90. For this reason, when the cover 2b is opened, generation of the laser beam can be stopped surely. On the other hand, electric power supply to the AND circuit 81 and the drive control circuit 82 is continued regardless of whether the cover 2b is opened or closed. For this reason, when the cover 2b is closed so that the interlock switch 92 is turned on, an over-voltage can be prevented from being applied on the AND circuit 81 and the drive control circuit 82. Accordingly, in the laser printer 1, the AND circuit 81 and the drive control circuit 82 can be effectively prevented from being broken by an over-voltage. That is, a current conduction path from the interlock switch 92 to the laser diode LD functions as a first power supply line whereas a current conduction path to the AND circuit 81 and the drive control circuit 82 functions as a second power supply line.

Because the laser printer control circuit 80 is disposed in a DC 3.3V signal system, the laser printer 1 is hardly affected by noise compared with the case were the laser printer control circuit 80 is disposed in a DC 5 V signal system. Although an AND circuit 81 having a relatively low tolerance to an over-voltage has to be provided to convert the voltage of the signal, in the laser printer 1 as described above, it is possible to protect the AND circuit 81 from such an over-voltage. Conventionally, there is a possibility that the AND circuit 81 will be broken by the signal output from the laser printer control circuit 80 when the signal is input to the AND circuit 81 not supplied with electric power. In this laser printer 1, however, there is no fear that the AND circuit 81 will be broken because electric power supply to the AND circuit 81 is continued as described above. Accordingly, in the laser printer 1, the influence of noise can be eliminated effectively while the AND circuit 81 etc. can be prevented from being broken, so that an accurate image can be formed.

According to the embodiment, the detection unit is an interlock switch 92 which is connected in series to the first power supply line and which is turned off when the cover is opened.

Any kind of sensor can be used as the detection unit for detecting the opening/closing of the cover. In this case, electric power supply based on the first power supply line can be stopped by software processing. In this case, it is however a possibility that electric power supply based on the first power supply line will be unable to be stopped surely at the time of the opening of the cover if software processing goes out of control.

On the contrary, in the embodiment, the mechanical interlock switch 92 which is turned off when the cover is opened is used as the detection unit and connected in series to the first power supply line. For this reason, electric power supply based on the first power supply line can be stopped surely when the cover is opened. In addition, the image forming apparatus 1 can be simplified in configuration.

In the configuration described above, electric power supply based on the first power supply line can be stopped surely when the cover is opened because a mechanical interlock switch 92 which is turned off when the cover is opened is connected in series to the first power supply line. Accordingly, in this configuration, there can be obtained an effect that the apparatus 1 can be simplified in configuration as well as electric power supply to the light-emitting device can be stopped surely when the cover is opened.

According to the embodiment, the light-emitting device control circuit includes the conversion circuit by which a control signal given from the outside of the light-emitting device control circuit is converted into a signal having a voltage value adapted to the drive control of the light-emitting device.

In the embodiment, the conversion circuit included in the light-emitting device control circuit operates so that a control signal given from the outside of the light-emitting device control circuit is converted into a signal having a voltage value adapted to the drive control of the light-emitting device. Such a conversion circuit may be often affected by an over-voltage. This tendency increases particularly when the voltage value of the control signal is lower than the voltage value adapted to the drive control. In the embodiment, however, an over-voltage can be effectively prevented from being applied on the conversion circuit.

In the configuration described above, an over-voltage can be prevented from being applied on the conversion circuit relatively easily affected by the over-voltage, so that the over-voltage preventing effect in the configuration becomes more remarkable. The effect becomes more remarkable particularly when the voltage value of the control signal given from the outside of the light-emitting device control circuit is lower than the voltage value adapted to the drive control of the light-emitting device.

According to the embodiment, the conversion circuit is an IC which receives the control signal as an input signal in its input terminal and which outputs a signal having a voltage value adapted to the drive control so that the output signal is switched on/off in accordance with the on/off of the control signal.

When the conversion circuit is formed from an IC, the conversion circuit is easily affected by an over-voltage. In the embodiment, however, an over-voltage can be effectively prevented from being applied on the conversion circuit.

In the configuration described above, an over-voltage can be prevented from being applied on the conversion circuit formed from an IC relatively easily affected by the over-voltage.

According to the embodiment, the voltage value of the control signal is to be lower than the voltage value adapted to the drive control.

When the voltage value of the control signal given from the outside of the light-emitting device control circuit is set to be lower than the voltage value adapted to the drive control of the light-emitting device, noise caused by any kind of signal concerning the control of the light-emitting device can be reduced.

In the configuration described above, noise caused by any kind of signal concerning the control of the light-emitting device can be reduced. Accordingly, in this configuration, there can be obtained an effect that the light-emitting device can be controlled more accurately to thereby form an image more accurately. This effect becomes more remarkable particularly when the speed of any kind of signal concerning the control of the light-emitting device is increased.

Incidentally, the invention is not limited to the aforementioned embodiment at all and various modifications may be made without departing from the gist of the invention. For example, an OR circuit may be used in place of the AND circuit 81 so that the same circuit as described above can be formed from the OR circuit. The AND circuit 81 (or the OR circuit) and the drive control circuit 82 may be integrated into a so-called drive IC. Also in this case, when the same configuration as described in the embodiment is used, electric power supply to the drive IC or the OR circuit can be continued regardless of whether the cover 2b is opened or closed while electric power supply to the laser diode LD can be stopped when the cover 2b is opened. Also in this case, the same operation and effect as described in the embodiment can be obtained. Besides the laser diode, any kind of device may be used as the light-emitting device. For example, an LED is used in place of the laser diode. Any kind of switching device such as an FET may be used in place of the transistor 90. Another detection unit maybe used in place of the interlock switch 92. The invention can be applied not only to the laser printer but also to any kind of image forming apparatus such as a facsimile machine or a composite machine.

While the invention has been described in conjunction with the specific embodiments described above, many equivalent alternatives, modifications and variations may become apparent to those skilled in the art when given this disclosure. Accordingly, the exemplary embodiments of the invention as set forth above are considered to be illustrative and not limiting. Various changes to the described embodiments may be made without departing from the spirit and scope of the invention.

1. An image forming apparatus comprising:
a light-emitting device that emits light, a photosensitive member being exposed to the light to form an electrostatic latent image on the photosensitive member;
an image forming portion that forms an image corresponding to the electrostatic latent image on a recording medium by electrophotography;
a cover that is opened and closed;
a light-emitting device control circuit that controls the light-emitting device;
a first power supply that supplies electric power to the light-emitting device;
a second power supply that supplies electric power to the light-emitting device control circuit; and
a controller that includes a detection unit that detects the opening and closing of the cover and a power supply controller to control the electric power so that the first power supply stops to supply the electric power to the light-emitting device while the second power supply supplies the electric power to the light-emitting device control circuit when the detection unit detects the cover is open.

2. The image forming apparatus according to claim 1, wherein the detection unit comprises an interlock switch which is connected in series to the first power supply, the interlock switch being turned off so as to stop to supply the electric power to the light-emitting device when the cover is opened.

3. The image forming apparatus according to claim 1, wherein the detection unit comprises a mechanical switch which is connected in series to the first power supply, the mechanical switch discontinuing the electric power to the light-emitting device when the cover is opened.

4. The image forming apparatus according to claim 1, wherein the light-emitting device control circuit includes a conversion circuit by which a control signal is converted into an output signal having a voltage value adapted to the light-emitting device.

5. The image forming apparatus according to claim 4, wherein the conversion circuit is an IC which receives the control signal and outputs the output signal so that the output signal is switched on and off in accordance with on and off of the control signal.

6. The image forming apparatus according to claim 4, wherein a voltage value of the control signal is lower than the voltage value of the output signal.

7. The image forming apparatus according to claim 1, wherein the light-emitting device control circuit includes an AND circuit by which a control signal is converted into an output signal having a voltage value adapted to the light-emitting device.

8. The image forming apparatus according to claim 7, wherein the AND circuit is an IC which receives the control signal and a constant voltage and outputs the output signal so that the output signal is switched on and off in accordance with on and off of the control signal.

9. The image forming apparatus according to claim 7, wherein a voltage value of the control signal is lower than the voltage value of the output signal.

10. The image forming apparatus according to claim 1, wherein the image forming portion further comprises:
a process unit, that accommodates the photosensitive member, detachably attached to a housing of the image forming apparatus, the process unit being attached to and detached from the housing when the cover is opened.
